(19) United States
(12) Patent Application Publication
(10) Pub. No.: US 2004/0234448 A1
(43) Pub. Date: Nov. 25, 2004

(54) Process for preparation of a catalyst based on zinc aluminate and the catalyst that is obtained

(76) Inventors: Gerard Hillion, Herblay (FR); Serge Leporq, La Ville (FR); Dominique Le Pennec, Orgerus (FR); Bruno Delfort, Paris (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/801,543

(22) Filed: Mar. 17, 2004

(30) Foreign Application Priority Data
Mar. 17, 2003 (FR) 03/03.317

(51) Int. Cl. C01F 7/02

(52) U.S. Cl. 423/600

(57) ABSTRACT

The preparation of a crush-resistant transesterification catalyst of the formula:

ZnAl₂O₄, xZnO, yAl₂O₃

wherein x and y are in the range of 0-2, comprises: stage (a) wherein the amount of zinc oxide necessary to the formation of said catalyst, in which at least a portion of the zinc oxide is replaced by an equivalent amount of at least one of zinc nitrate or carbonate, is mixed with water and nitric acid; stage (b) wherein the resultant mixture is mixed with an alumina gel peptized in the presence of a water/nitric acid mixture, so as to form a paste; stage (c) wherein the resultant paste is extruded; stage (d) wherein the extruded paste is dried in phases, the first at a temperature of less than 100° C., and the second at a temperature of at least 100° C.; and a stage (e) wherein the extruded and dried paste is calcined.

This invention relates to the preparation of catalysts based on zinc aluminate and the catalysts that are obtained.

The process of the invention comprises a scheme of stages of mixing, kneading, extrusion, drying and calcination, conducted under particular conditions that will be defined below.

It is known that zinc aluminates can be used as catalysts in the production of C1 to C6 monoalcohol esters of C6 to C26 fatty acids from different oil sources, without the metal elements that constitute the catalyst being found in solution in the reaction effluents.

Processes for preparation of such catalysts have already been described in the literature and in various French Patents issued in the name of the same applicant: FR-B-2 752 242, 2 772 756 and 2 794 768, without the resistance to crushing having been taken into consideration.

The object of this invention is to provide a new process for obtaining a catalyst that comprises zinc aluminate and that corresponds to the formula:

ZnAl₂O₄, xZnO, yAl₂O₃

whereby x and y are encompassed between 0 and 2, in which ZnAl₂O₄ has more particularly a spinel-type structure; said catalyst generally exhibits a SHELL resistance to crushing that is greater than or equal to 1 MPa and can be used in heterogeneous catalysis processes in a fixed bed.

The process of the invention can be defined by the fact that it successively comprises:

A stage (a) in which the amount of zinc oxide that is necessary to the formation of said catalyst, in which at least a portion of the zinc oxide is replaced by an equivalent amount of at least one zinc salt that is selected from among the nitrate and the carbonate, is mixed with water and nitric acid;

A stage (b) in which the mixture that was previously obtained is mixed with an alumina gel that is peptized in the presence of a water/nitric acid mixture, so as to form a paste;

A stage (c) in which the paste that is obtained from the mixing stage is extruded under pressure;

A stage (d) in which the extruded paste is dried in two successive phases, the first at a temperature of less than 100° C., and the second at a temperature of at least 100° C.;

And a stage (e) in which the extruded and dried paste is calcined, for example at a temperature of 700° C. for 2 hours.

In the catalysts that are obtained by the process of the invention, the mass ratio of Al₂O₃/ZnO is generally encompassed between 95/5 and 56/44; it is preferably 70/30.

In a surprising way, it is noted that the order of introduction of the various components, the partial or total replacement of the zinc oxide by another zinc compound that can decompose thermally (the nitrate or the carbonate), as well as the addition of more or less large amounts of nitric acid in solution in water acting as a peptization agent of alumina or as a chemical agent that makes it possible to transform zinc oxide totally or partially into zinc nitrate, could be responsible for the modification of certain physical or mechanical properties of the catalyst.

In the process for preparation of the catalysts of the invention, the substitution of ZnO by nitrate or carbonate can be between 10 and 100% of the total zinc and preferably between 25 and 40% of the total zinc.

In contrast, the conditions of the post-treatments, such as the drying and the calcination, can also influence the characteristics and in particular the resistance to crushing.

In stage (a), generally the zinc salt that is selected from among the nitrate and the carbonate (as well as optionally zinc oxide) is mixed with an aqueous nitric acid solution for a period of between 30 and 60 minutes in a container that is equipped with a stirring mechanism until the consistency of a thick cream is achieved.

Stage (b) for thorough mixing of the alumina gel with the mixture above is generally carried out in a mixer-extruder. In a first step, the alumina gel to which is quickly added the zinc oxide mixture (replaced completely or partially by nitrate and/or zinc carbonate) and water/nitric acid, is introduced. The mixing period is encompassed between, for example, 60 and 120 minutes. The temperature gradually rises to reach a value that is encompassed between, for example, 60 and 65° C. An addition of water can be considered so that the consistency of the paste corresponds to the criteria of one skilled in the art.

Extrusion stage (c) is generally carried out from a die with a diameter of between 1.5 and 3.7 mm of diameter. During this stage, the pressure that is to be exerted on the dye is generally greater than 20 bar (2 MPa) so as to obtain compact extrudates that have a flawless surface condition. The extrudates that are recovered at the end of the operation when the pressure is less than this value of 2 MPa are not generally preserved.

In stage (d), generally carried out in a ventilated oven, the drying conditions may modify certain mechanical properties of the catalyst. Actually, if the drying temperature is greater than or equal to 100° C., the quick departure by boiling of the water that is contained in the core of the extrudates can embrittle the latter. It is therefore recommended to operate this drying stage according to at least two successive temperature phases: the first phase conducted at a temperature that is lower than the boiling point of the water, for example at 80° C. for 3 hours, then a second phase conducted at a temperature of at least 100° C.; this second phrase can comprise, for example, a stage of 2 hours at 100° C. then a stage of 2 hours at 150° C. At the end of this treatment, it is suitable that the extrudates no longer show weight loss.

In stage (e), generally the extrudates are calcined in a muffle furnace so as to form the spinel with zinc aluminate. The calcination conditions can be as follows:

A calcination time that is encompassed between 3 and 4 hours at a temperature that is encompassed between 400 and 700° C., preferably 2 hours at a temperature of 700° C.;

With a gradient for temperature rise that is encompassed between 3 and 6° C./minute.

Under these conditions, the residual content of zinc oxide (zincite), measured by X diffraction, is low, often less than 2% by mass.

The characterization of the zinc aluminate spinel that is called “Gahnite” and is defined by formula ZnAl₂O₄ can also be carried out by X diffraction.

The mass content of the catalyst zinc element that is obtained can be determined by X-fluorescence. It is encompassed, in the example that uses a respective mixture of alumina and zinc oxide of 70/30 by weight, between 22 and 24% of zinc.

One of the mechanical properties of the extrudates is measured by the SHELL resistance to crushing test that is a referenced method (Shell Method Series SMS1471-74 “Determination of Bulk Crushing Strength of Catalysts”; Compression-Sieve Method). It makes it possible to determine the resistance to crushing in a solid bed and more particularly catalysts in the range of pressures of between 0 and 2.33 MPa. It applies to balls or to extrudates (having a length that is less than or equal to 6 mm).

The principle of this method is as follows:

After having placed about 20 cm³ of catalyst in a metal cylinder with a known inside section, a force that grows in stages is applied via a piston. The fines that are obtained with different pressures are separated by sieving and weighed. The sieve that is used has a mesh of 420 μm.

This test is used primarily for the operation of fixed-bed catalysts. The bed resistance to crushing is determined by the pressure in megaPascal (MPa) for which the amount of accumulated fines that pass through the sieve rises to 0.5% by mass of the sample. This value is obtained by plotting on a graph the mass of fines that is obtained based on the force that is applied to the catalyst bed and by interpolating at 0.5% by mass of accumulated fines.

A value that is greater than or equal to 1 MPa makes it possible to ensure a loading of the catalyst by reducing the risks of formation of fines that can clog the strainers or filters that are placed downstream from the catalysis reactor and that could create large feedstock losses in the installation.

In contrast, the mass composition of different metal elements as well as certain physical and mechanical characteristics of the catalyst are parameters that should be well controlled. These are in particular the Zn/Al ratio that is expressed in % by weight (determined by X fluorescence), ZnAl₂O₄ contents (formed spinel) and residual free ZnO (determined by X diffraction), the BET surface area, the pore volume, the SHELL resistance to crushing, as well as the packing density.

The catalysts that are prepared as described in the invention make it possible to transesterify vegetable oils or animal oils, which may or may not be neutral, by heterogeneous catalysis with C1 to C6 monoalcohols.

The following examples illustrate the invention but should in no way limit its scope.

In these examples, to prepare zinc aluminates, the following products and reagents were used:

Condéa alumina gel (water content: 25.925% by weight);

“active” Bayer zinc oxide (water content: 5% by weight);

Prolabo RP 68% nitric acid;

Zinc nitrate with 6 water molecules (Prolabo RP);

Deionized water.

The equipment that is used to carry out the mixing and the extrusion of Examples 1 to 5 is a Z-arm mixing machine of Aoustin MX0.4 type and a piston extruder of RETMA type with a die with a diameter of 3 mm.

For more significant preparations, the equipment that is used is an Aoustin MX2E two-screw mixer-extruder for Examples 6, 7 and 8.

### EXAMPLE 1 (FOR COMPARISON)

75.6 g of “Condéa” alumina gel, or the equivalent of 56 g of dry gel, is introduced into an Aoustin MX0.4-type mixer with 75 ml of aqueous solution that contains 4.4 g of nitric acid with 68% by weight of purity. It is mixed for 30 minutes.

24 g of “active” zinc oxide is added. It is mixed for 1 hour and 15 minutes by adding at regular intervals 9 ml of water on four occasions or a total of 36 ml of water.

Extrusion is then performed on the RETMA extruder that is equipped with a die with a diameter of 3 mm.

The Al₂O₃/ZnO mass ratio (relative to the dry material) is 70/30.

The extrudates that are obtained are dried for 4 hours at 100° C. in a ventilated oven, then at 150° C. for 3 hours, after which a calcination stage is carried out under a stream of 9.6 l/h of dry air in a tubular furnace that is brought to the temperature of 700° C. at a rate of 7° C./minute. The temperature of 700° C. is held for 2 hours. It is cooled in the furnace under a stream of air.

The SHELL crushing values are noted in Table 1.

### EXAMPLE 2

An identical Al₂O₃/ZnO mass ratio is preserved, but by substituting a portion of the ZnO by zinc nitrate, whereby the latter represents 33% of the total zinc.

The zinc nitrate is mixed in advance in the presence of zinc oxide before the introduction of the alumina gel.

In the Aoustin MX0.4 mixer, 16 g of “active” ZnO is introduced, then an aqueous solution that consists of 30 g of Zn(NO₃)₂, 6H₂O (or the equivalent of 8 g of ZnO) and 15 ml of deionized water is introduced. It is mixed for 30 minutes, then 75.6 g of hydrated alumina gel (or 56 g converted to dry material) and 60 ml of an aqueous solution that contains 6 g of 68% nitric acid are added. It is mixed for 75 minutes. A firm paste is obtained that is introduced into the RETMA piston extruder. It is extruded from a die with a 3 mm diameter. The extrudates that are obtained are dried for 4 hours at 100° C. in a ventilated oven, then at 150° C. for 3 hours, followed by a calcination stage under a stream of 9.6 l/h of dry air in a tubular furnace that is brought to the temperature of 700° C. at a rate of 7° C./minute. The temperature of 700° C. is held for 2 hours. It is cooled in the furnace under a stream of air.

The SHELL crushing values are noted in Table 1.

### EXAMPLE 3

A variant that relates to the calcination stage is carried out on a portion of the extrudates that were obtained in Example 2 after the drying stage. The calcination stage takes place, in this case, under a moist atmosphere in a tubular furnace. The conditions are as follows: the temperature of the furnace is raised at a rate of 7° C./minute up to 700° C. The flow rate of 9.6 l/h of charged air with 50% humidity is introduced starting from 200° C. The temperature of 700° C. is held for 2 hours. The cooling of the extrudates is carried out under a stream of dry air starting from 400° C. and until cooling is completed.

The SHELL crushing values are noted in Table 1.

### EXAMPLE 4

The same amounts of reagents as in Example 2 are used, but the order of introduction of the various components is modified as follows:

The alumina gel is mixed in advance with a nitric peptization solution, then an aqueous mixture of zinc nitrate and zinc oxide is introduced.

Into the Aoustin MX0.4 mixer, 75.6 g of alumina gel (or 56 g of dry material), then 60 ml of aqueous solution that contains 6 g of 68% nitric acid are introduced, and it is mixed for 30 minutes. 16 g of ZnO, then 50 g of the solution that consists of 30 g of zinc nitrate and 20 ml of water are successively added. This mixture is mixed for 75 minutes.

A firm paste is obtained that is introduced into the RETMA piston extruder. It is extruded from a die with a 3 mm diameter. The extrudates that are obtained are dried for 4 hours at 100° C. in a ventilated oven, then at 150° C. for 3 hours, after which a calcination stage is carried out in a muffle furnace at 700° C. for 2 hours. It is cooled in the furnace under an air atmosphere.

The SHELL crushing values are noted in Table 1.

### EXAMPLE 5

The same operating procedure as in Example 2 is followed, but with a substitution of 50% in ZnO equivalent by zinc nitrate, instead of the 33% considered in Example 2.

Into the Aoustin MX0.4 mixer, 12 g of “active” ZnO is introduced, then an aqueous solution that consists of 45 g of Zn(NO₃)₂, 6H₂O (or the equivalent of 8 g of ZnO) and 15 ml of deionized water is added. It is mixed for 30 minutes, then 75.6 g of hydrated alumina gel (or 56 g converted to dry material) and 60 ml of an aqueous solution that contains 6 g of 68% nitric acid are added. It is mixed for 75 minutes. The following operations are identical to those described in detail in Example 2.

The SHELL crushing values are noted in Table 1.

TABLE 1
Results of the SHELL Resistance to Crushing Test

| Catalysts in the | Resistance to |
|---|---|
| Form of Extrudates | Crushing (Expressed in MPa) |
| Example 1 | 0.23 |
| Example 2 | 0.83 |
| Example 3 | 0.49 |
| Example 4 | 0.43 |
| Example 5 | 0.91 |

### EXAMPLE 6

Into an AOUSTIN MX2E two-screw mixer-extruder, 483.5 g of alumina gel (Condéa) that corresponds to 350 g of alumina that is converted to the dry weight and 150 g of “active” zinc oxide (Bayer) that corresponds to 142.5 g of zinc oxide that is converted to the dry weight are introduced so as to obtain a thorough mixing of the oxides. Then, 370 ml of a nitric solution that contains 50 g of nitric acid with 68% purity (or 34 g of pure HNO₃) is quickly added to this stirred mixture. The mixing is ensured for 20 minutes until a homogeneous paste with a firm consistency is obtained. The direction of rotation of the screw is reversed, and the paste is easily extruded from a die with a 3 mm diameter. 833 g of extrudates is obtained.

The drying is carried out in a ventilated oven for 4 hours at 100° C., then for 3 hours at 150° C. After cooling, 510 g of extrudates is obtained.

The calcination is carried out in a muffle furnace in air. The introduction of the extrudates is done with a cold furnace. The rise in temperature is programmed with a temperature gradient of 10° C./minutes until the temperature of 700° C. is reached, which is held for 2 hours. The cooling is carried out in the furnace until the cooling is completed. Ultimately, 423 g of extrudates is obtained.

The characterization of the catalyst is provided in Table 2.

### EXAMPLE 7

Into a 2-liter beaker with a magnetized bar, 450 g of crystallized zinc nitrate with 6 water molecules, then 225 ml of deionized water and 45 g of 68% nitric acid are introduced.

After the zinc nitrate is dissolved, 240 g of zinc oxide is added, then it is left in contact while being stirred for 45 minutes.

Into the two-screw mixer-extruder, 1134 g of alumina gel, or the equivalent of 840 g of dry product, is introduced. From the starting of the mixer arms, the previously obtained mixture that consists of zinc nitrate, zinc oxide, nitric acid and water is added. After 2 minutes of mixing, the peptization of the alumina is induced by adding 700 ml of an aqueous solution that contains 45 g of 68% nitric acid. The beaker that has contained the zinc compounds is rinsed with 55 ml of water, and the rinsing water is added to the paste that is present in the mixer. It is mixed for 75 minutes in the open mixer until a firm homogeneous paste is obtained.

It is extruded from a die with a 3 mm diameter after the direction of rotation of the screw is reversed. 3116 g of extrudates is obtained.

The drying is carried out in a ventilated oven at 100° C. for 4 hours, than at 150° C. for 3 hours. After cooling, 1618 g of extrudates is obtained.

The calcination is carried out in a muffle furnace with introduction of the “cold furnace” product. The rise in temperature is programmed with a gradient of 10° C./minute until the temperature of 700° C., which is held for 2 hours, is reached. Ultimately, after cooling in the air, 1257 g of extrudates is obtained.

The characterization of the catalyst is provided in Table 2.

TABLE 2
Summary of the Results of the Catalysts of Examples 6 and 7

| | | Catalyst | Catalyst |
|---|---|---|---|
| Analyses | Units | of Example 6 | of Example 7 |
| BET Specific | m²/g | 142 | 92 |
| Surface Area | | | |
| Mercury Porosity: | | | |
| Volume | ml/g | 0.52 | 0.45 |
| of Hg | | | |
| Grain | g/ml | 1.284 | 1.460 |
| Density | | | |
| PAF (Fire Loss) 3 | % by Weight | 7.0 | 4.3 |
| Hours at 1000° C. | | | |
| SHELL Crushing | MPa | 0.71 | 1.05 |
| Packing Density | g/ml | 0.780 | 0.796 |
| Mean Diameter | mm | 2.7 | 2.4 |
| Geometry | | | |
| Zinc Content (X | % by Weight | 23 | 23.2 |
| Fluorescence) | | | |
| ZnAl₂O₄ Content | % by Weight | 55 | 61.0 |
| (Gahnite) | | | |
| Al₂O₃ Content | % by Weight | 40 | 37.2 |
| (Gamma-Alumina) | | | |
| ZnO Content | % by Weight | 4.0 | 1.8 |
| (Zincite) | | | |

### EXAMPLE 8

While preserving the Al₂O₃/ZnO mass ratio of 70/30, a variant to this method of preparation made it possible to obtain good mechanical performance levels with the extrudates by promoting, under certain conditions, the in situ formation of zinc nitrate by direct action of an aqueous solution of nitric acid and zinc oxide.

This operating mode exhibits certain advantages, in particular making it possible to use a single zinc compound, the “active” zinc oxide of Bayer, and also to reduce on the order of 30% the amount of nitrous vapors that are generated during the calcination stage.

Into a 2-liter beaker with a magnetized bar, 360 g of “active” zinc oxide is introduced, then 900 ml of an aqueous solution that contains 180 g of 68% nitric acid is poured into it; the stirring of the mixture continues for 30 minutes, then it is left in contact for 24 hours at ambient temperature.

Into the two-screw mixer-extruder, 1134 g of alumina gel or the equivalent of 840 g of dry product is introduced. From the starting of the mixing arms, the mixture previously obtained and consisting of a zinc oxide suspension is added into the water/nitric acid mixture. The container that has contained the ZnO/water-nitric acid mixture is then rinsed with 250 ml of an aqueous solution that contains 45 g of 68% nitric acid. It is mixed for 90 minutes by sequentially adding 400 ml of water so as to obtain a flexible and firm paste consistency. It is extruded from a die with a 3 mm diameter after the direction of rotation of the screw is reversed.

The drying is carried out in a ventilated oven at 100° C. for 4 hours, then at 150° C. for 3 hours.

The calcination is carried out in a muffle furnace with an introduction of the cold furnace product. The rise in temperature is programmed with a gradient of 10° C./minute to reach the temperature of 700° C. that is held for 2 hours. It is cooled slowly in the furnace under an air atmosphere.

The extrudates that are thus obtained have a SHELL crushing value of 1.12 MPa.

1. Process for preparation of a catalyst that comprises zinc aluminate and that corresponds to the formula:
ZnAl₂O₄, xZnO, yAl₂O₃
whereby x and y are encompassed between 0 and 2, characterized by the fact that it successively comprises:
A stage (a) in which the amount of zinc oxide that is necessary to the formation of said catalyst, in which at least a portion of the zinc oxide is replaced by an equivalent amount of at least one zinc salt that is selected from among the nitrate and the carbonate, is mixed with water and nitric acid;
A stage (b) in which the mixture that was previously obtained is mixed with an alumina gel that is peptized in the presence of a water/nitric acid mixture, so as to form a paste;
A stage (c) in which the paste that is obtained from the mixing stage is extruded under pressure;
A stage (d) in which the extruded paste is dried in two successive phases, the first at a temperature of less than 100° C., and the second at a temperature of at least 100° C.;
And a stage (e) in which the extruded and dried paste is calcined.

2. Process according to claim 1, characterized in that stage (a) is carried out over a period encompassed between 30 and 60 minutes in a container that is equipped with a stirring mechanism until the consistency of a thick cream is achieved.

3. Process according to claim 1, wherein mixing stage (b) is carried out in a mixer-extruder.

4. Process according to claim 3, wherein into stage (b), the alumina gel to which the mixture of zinc salt, if necessary zinc oxide, and water/nitric acid is added is introduced in a first step, whereby the mixing time is encompassed between 60 and 120 minutes.

5. Process according to claim 3, wherein during the mixing, the temperature gradually rises to reach a value of between 60 and 65° C.

6. Process according to claim 3, wherein water is added during the mixing to reach a suitable consistency of the paste.

7. Process according to claim 1, wherein stage (c) consists in extruding the paste that is thus obtained from a die with a diameter of between 1.5 and 3.7 mm of diameter.

8. Process according to claim 8, wherein in stage (c), a pressure of higher than 2 MPa is exerted on the die so as to obtain compact extrudates that have a flawless surface condition.

9. Process according to claim 7, wherein when, at the end of the operation, the pressure again becomes less than 2 MPa, the recovered extrudates are not preserved.

10. Process according to claim 1, wherein drying stage (d) is carried out in a ventilated oven.

11. Process according to claim 10, wherein said first drying phase is operated at about 80° C. for 3 hours, then said second drying phase is operated in two stages, at 100° C. for about 2 hours and then at about 150° C. for about 2 hours.

12. Process according to claim 1, wherein stage (e) is carried out at a temperature of between 400 and 700° C. for a period of between 2 and 4 hours.

13. Process according to claim 12, wherein stage (e) is carried out at a temperature of about 700° C. for about 2 hours with a temperature rise gradient encompassed between 3 and 6° C./minute.

14. Catalyst that comprises zinc aluminate and that corresponds to the formula:
ZnAl₂O₄, xZnO, yAl₂O₃
whereby x and y are encompassed between 0 and 2, obtained by a process according to claim 1.

15. Catalyst according to claim 14, wherein it exhibits a residual zincite content, measured by X diffraction, less than 2% by mass.
